(19) United States
(12) Patent Application Publication
(10) Pub. No.: US 2016/0062847 A1
(43) Pub. Date: Mar. 3, 2016

(54) INSTALLING APPLICATIONS VIA RESTORATION OF A FALSE BACKUP

(71) Applicant: YANDEX EUROPE AG, Luzern (CH)

(72) Inventors: Vasily Borisovich FILIPPOV, Saint-Petersburg (RU); Sergey Alexandrovich ANTONOV, Saint-Petersburg (RU); Ildar Rafaelovich KARIMOV, Zagorodnyi (RU); Viktor Valerevich SHAROV, Saint-Petersburg (RU)

(21) Appl. No.: 14/926,695

(22) Filed: Oct. 29, 2015

Related U.S. Application Data
(63) Continuation of application No. PCT/IB2014/062224, filed on Jun. 13, 2014.

(30) Foreign Application Priority Data
Oct. 21, 2013 (RU) 2013146656

(51) Int. Cl. G06F 11/14; G06F 17/30; G06F 9/445

(52) U.S. Cl. CPC G06F 11/1464; G06F 8/61; G06F 17/30073; G06F 2201/84

(57) ABSTRACT

Method of and system for bulk installing on a first digital electronic device, from a second digital electronic device in communication with first digital electronic device, a plurality of applications not already installed on first digital electronic device, comprising: receiving by second digital electronic device instruction to bulk install plurality of applications on first digital electronic device; creating by second digital electronic device a false backup archive containing plurality of applications, false backup archive having sufficient attributes of a true backup archive creatable by a backup operation in respect of first digital electronic device to be compatible with a restoration operation corresponding to backup operation, restoration operation executable to transfer contents of false backup archive to a non-transitory computer-readable storage medium of first digital electronic device; and causing by second digital electronic device execution of restoration operation, resulting in bulk installation of plurality of applications on first digital electronic device.

### CROSS-REFERENCE

The present application claims convention priority to Russian Utility Model Application No. 2013146656, filed on Oct. 21, 2013, entitled “CΠOCO [symbol] [symbol] C [symbol] CTEMA O [symbol] HOBPEMEHHO [symbol] [symbol] CTAHOB [symbol] H MHO [symbol] ECTBA ΠP [symbol] JIO [symbol] EH [symbol] [symbol] C ΠOMO [symbol] BOCCTAHOB [symbol] EH [symbol] [symbol] [symbol] O [symbol] HOΓO PE3EPBHOΓO APX [symbol] BA” (METHOD OF AND SYSTEM FOR BULK INSTALLING A PLURALITY OF APPLICATIONS VIA RESTORATION OF A FALSE BACKUP ARCHIVE) and is a continuation of PCT/IB2014/062224 filed on Jun. 13, 2014, entitled “INSTALLING APPLICATIONS VIA RESTORATION OF A FALSE BACKUP”, the entirety of both of which are incorporated by reference herein.

### FIELD OF THE TECHNOLOGY

The present technology relates to bulk installing of applications on a digital electronic device via restoration of a false backup archive.

### BACKGROUND

There are hundreds of thousands of software applications available to be installed on digital electronic devices such as smartphones, tablet computers, and other digital electronic devices, and many more are released every day. When a device is first purchased, it normally includes a small set of preinstalled applications having been selected by the manufacturer and/or the retailer of the device. If the user of the device wants to use any additional applications not included among the preinstalled applications, the user is expected to acquire and install each additional application on his or her own.

Methods of installing these applications have evolved significantly in recent years. In the past, applications were typically distributed on a computer-readable removable storage medium such as a diskette or a CD-ROM and installed on the device via a disk drive. As high-speed Internet connections have become more widespread, applications have increasingly come to be installed by downloading them from a web server and executing an installation routine on the device. On some newer device platforms, users may now purchase and install applications from online repositories such as APPLE'S APP STORE, GOOGLE PLAY, and YANDEX.STORE.

Although new distribution methods have made installation of applications on digital electronic devices more convenient, there remains room for improvement in certain respects. In particular, installing applications one-by-one can be confusing for inexperienced users and time-consuming even for those with more experience.

### SUMMARY

It is thus an object of the present technology to ameliorate at least some of the inconveniences present in the prior art. The present technology comprises a novel use of conventional technology for backing up and restoring data stored on digital electronic devices, enabling efficient bulk installation of multiple applications on a first digital electronic device from a second digital electronic device.

Conventionally, backup technology is used as a measure to prevent loss of data stored on a digital electronic device as a result of damage to or loss of the device, human error, or a failure of the device's hardware or software. A backup operation creates a backup archive in respect of the device by copying into the backup archive at least some of the information stored on at least one computer-readable storage medium of the device. The backup archive created by the backup operation possesses attributes rendering it compatible with a corresponding restoration operation executable to transfer contents of the backup archive back to the device. The backup archive may be stored as a single file, as many files, or as one or more entries in one or more databases. The transfer of the backup archive's contents may include copying those contents to a computer-readable storage medium of the device and/or other steps to render the contents available for use on the device.

The present technology comprises a novel use of this conventional backup/restoration framework, wherein a second device creates a false backup archive containing applications and/or other information not previously installed on a first device, the false backup archive appearing to the corresponding restoration operation as though it were a true backup archive and therefore being compatible with the restoration operation. The restoration operation is then executed in respect of the false backup archive in order to restore the false backup archive from the second device to the first device. Because the false backup archive includes the applications to be installed, the restoration of the contents of the false backup archive results in the installation of those applications on the device.

In the context of the present specification, a “true backup archive” is a backup archive having been created by an actual backup operation executed in respect of a digital electronic device, whereas a “false backup archive” is an archive created at least in part by executing at least one operation other than an actual backup operation in respect of a digital electronic device. In other words, creating a false backup archive may or may not include executing a backup operation, but it may not consist of nothing more than executing a backup operation. As non-limiting examples, a false backup archive could be created by manipulating the contents of a true backup archive or by assembling a new archive from scratch having sufficient attributes of a true backup archive.

Thus, in one aspect, implementations of the present technology provide a method of bulk installing on a first digital electronic device, from a second digital electronic device in communication with the first digital electronic device, a first plurality of applications not already installed on the first digital electronic device, the method comprising:

(a) receiving by the second digital electronic device instruction to install the first plurality of applications on the first digital electronic device;
(b) creating by the second digital electronic device a false backup archive containing the first plurality of applications, the false backup archive having sufficient attributes of a true backup archive creatable by a backup operation in respect of the first digital electronic device to be compatible with a restoration operation corresponding to the backup operation, the restoration operation executable to transfer contents of the false backup archive to a non-transitory computer-readable storage medium of the first digital electronic device; and
(c) causing by the second digital electronic device execution of the restoration operation, whereby the first plurality of applications is bulk installed on the first digital electronic device.

Some operating systems, such as variants of UNIX, LINUX, MICROSOFT WINDOWS, and others, require a software process to possess special permissions in order to perform installation of at least some applications. This is especially true of the installation of system applications. In many cases, the special permissions required are those of a superuser with general permissions on the device (e.g. “root” on UNIX and LINUX systems or “Administrator” on MICROSOFT WINDOWS systems). In some implementations of the present technology, an operating system of the first digital electronic device requires at least one operation to be executed with superuser permissions on the first digital electronic device, and the restoration operation is executed without superuser permissions on the first digital electronic device. In some further implementations, the operating system requires installation of system applications on the first digital electronic device to be executed with superuser permissions, and the first plurality of applications includes no system applications.

One technique that may be employed to carry out the creation of the false backup archive is to combine the applications to be installed with a true backup archive, for example by adding the applications to the true backup archive or by copying both the applications and the contents of the true backup archive into a new backup archive. Thus, in some implementations of the present technology, (b) includes combining the first plurality of applications with a true backup archive. Moreover, the true backup archive may or may not have been created by executing a backup operation in respect of the first digital electronic device, and the true backup archive may or may not include one or more applications already installed on the device and may or may not also include state information associated with the one or more applications, such state information enabling the application(s) to maintain run-time information for later use (e.g. a browsing history of a web browser). Thus, in some further implementations, (b) includes creating the true backup archive via the backup operation in respect of the first digital electronic device. In some further implementations, the true backup archive contains at least one application already installed on the first digital electronic device, and (b) includes including the at least one application already installed in the false backup archive. In some further implementations, the true backup archive contains state information associated with the at least one application already installed, and (b) includes including the state information in the false backup archive.

The particular characteristics of the false backup archive created by the second digital electronic device may be adjusted depending on one or more characteristics of the first digital electronic device. Thus, in some implementations, (b) includes determining at least one attribute of the false backup archive based on at least one attribute of the first digital electronic device. The attribute(s) in question may be determined in advance, or in some cases, they may be acquired from the first digital electronic device. Thus, in some further implementations, (b) further includes receiving by the second digital electronic device from the first digital electronic device the at least one attribute of the first digital electronic device. In other implementations, the at least one attribute of the first digital electronic device may be received by the second digital electronic device from a user via a user interface, or from another device. Based on the one or more attributes, the second digital electronic device may select which application or which version of an application should be installed on the first digital electronic device. For example, if the device does not have a touchscreen, a non-touchscreen version may be installed instead of a touchscreen version, or perhaps another application entirely may be substituted for an application requiring a touchscreen. Thus, in some further implementations, (b) further includes selecting a version of at least one application included in the first plurality of applications based on the at least one attribute of the first digital electronic device.

Any number of attributes of the first digital electronic device may be taken into account, including, as non-limiting examples, the manufacturer, model number, hardware attributes such as the size or resolution of a display of the first digital electronic device, and/or versions of operating systems or software libraries (including, for example, the “API level” of a GOOGLE ANDROID platform). Thus, in some further implementations, the at least one attribute of the first digital electronic device includes at least one of a manufacturer and a model number. In some further implementations, the at least one attribute of the first digital electronic device includes at least one hardware attribute of the first digital electronic device. In some further implementations, the first digital electronic device includes a display and the at least one hardware attribute includes at least one of a size of the display and a resolution of the display. In some further implementations, the at least one attribute of the first digital electronic device includes at least one of a version of an operating system of the first digital electronic device and a version of a software library installed on the first digital electronic device.

Program instructions executable to perform the steps of receiving instruction to install the applications, creating the false backup archive, and causing execution of the restoration operation may, prior to execution of those steps, be loaded by the second digital electronic device from a portable removable non-transitory computer-readable storage medium, such as a USB flash drive, external hard disk drive or solid state drives, a magnetic medium such as a diskette or tape, an optical disc such as a CD, DVD, or BLU-RAY DISC, or another portable removable storage medium. Thus, in some implementations of the present technology, the method further comprises, before any of (a) to (c), loading by the second digital electronic device, from a portable removable non-transitory computer-readable storage medium connected to the second digital electronic device, program instructions for carrying out (a) to (c). One advantage of loading the program instructions from such a removable storage medium is that it may enable steps (a) to (c) to be carried out without necessarily installing programs or data on the second digital electronic device, meaning that after bulk installation of the first plurality of applications on the first digital electronic device is complete, the second digital electronic device could be returned to its original state simply by removing or disconnecting the portable removable non-transitory computer-readable storage medium (after having alerted the second digital electronic device of the anticipated removal, if necessary).

In some implementations, the first digital electronic device is a mobile communications device. Non-limiting examples of mobile communications devices include mobile telephones, smartphones, wearable computers, tablet computers, and notebook computers equipped with network communications hardware. In some further implementations, the first digital electronic device and the second digital electronic device are in communication via a USB cable. In other implementations, communication between the two devices may occur via means other than a USB cable, for example any number of wired or wireless communication links such as ETHERNET, BLUETOOTH, infrared (IRDA), radio-frequency identification (RFID), or near field communication (NFC).

The second digital electronic device may include a user interface allowing a user to select applications to be installed on the first digital electronic device. Thus, in some implementations, (a) includes receiving by the second digital electronic device via a user interface of the second digital electronic device a selection of at least one first application to be installed on the first digital electronic device, and the first plurality of applications includes the at least one first application. If the second digital electronic device includes a display (such as a screen or a head-mounted display), the user may be presented with graphical means to select applications to be installed. Thus, in some further implementations, the user interface is a graphical user interface, and (a) further includes displaying via the graphical user interface a graphical representation of a second plurality of applications selectable for installation on the first digital electronic device, the second plurality of applications including the at least one first application.

In addition to the application(s) selected by the user via the user interface, some implementations of the present technology may include other applications in the false backup archive. This may be the case, for example, if a manufacturer, retailer, or service provider mandates that certain applications be installed, whether for technical, legal, commercial, or other reasons. Thus, in some further implementations, the first plurality of applications further includes at least one second application not having been selected via the user interface.

Along with the application(s) themselves, application configuration information such as settings, user preferences, application usage history, or other information in respect of one or more of the application(s) included in the false backup archive may also be used to configure those application(s). Implementations of the present technology which include this feature thus enable pre-configuration of one or more application(s), such that after restoration of the false backup archive to the first digital electronic device, those applications are already configured according to the application configuration information. Thus, in some implementations, the method further comprises (d) receiving, by the second digital electronic device, application configuration information in respect of at least one third application in the first plurality of applications; and (b) includes configuring the at least one third application using the application configuration information. In some further implementations, the application configuration information includes user account information of a user of the first digital electronic device, the user account information uniquely identifying the user of the first digital electronic device to at least one online service associated with the at least one third application. Such user account information could include a username, password, and/or other information about the user. Online services could include web or cloud-based services accessible via the Internet, for example.

In some further implementations, at least some of the application configuration information is received by the second digital electronic device via the user interface of the second digital electronic device. In some implementations, at least some of the application configuration information is received by the second digital electronic device via other means, such as communication with another device.

Along with the applications(s) themselves and optional application configuration information, information for configuration of the device may also be included in the false backup archive or otherwise used in the process of creating of the false backup archive. Thus, in some implementations, the method further comprises (e) receiving, by the second digital electronic device, device configuration information in respect of the first digital electronic device; and (b) includes including the device configuration information in the false backup archive. Such device configuration may include codes or other information used to pair the first digital electronic device with another device, perhaps via BLUETOOTH, ANT+, IrDA, RFID, NFC, or some other protocol. Thus, in some further implementations, the device configuration information includes information for pairing the first digital electronic device with at least one third digital electronic device. Device configuration information may be used to enable, disable, configure, or otherwise vary the operability of the device with respect to one or more communications network(s). For example, if the first digital electronic device is a “locked” mobile telephone configured to operate on a single mobile communications network, a code could be included to “unlock” the phone and render it available for use on other mobile communications networks. Thus, in some further implementations, the device configuration information includes information for varying operability of the first digital electronic device with respect to at least one communications network. Other passcodes or unlock codes of the first digital electronic device could also be included. Thus, in some further implementations, the device configuration information includes one of a passcode and an unlock code of the first digital electronic device.

In some further implementations, at least some of the device configuration information is received by the second digital electronic device via the user interface of the second digital electronic device. In some implementations, at least some of the device configuration information is received by the second digital electronic device via other means, such as communication with another device.

In some implementations, the method further comprises (f) receiving, by the second digital electronic device, additional content; and (b) includes including the additional content in the false backup archive. Examples of such additional content include documents (such as a user manual), images, videos, audio, references to other content such as links to web sites or cloud storage servers, or any other type of information for use with the first digital electronic device.

The method may also include detecting that the restoration operation is compatible with the device, proceeding with bulk installation of the applications on the device via restoration of a false backup archive, detecting that the restoration operation is not compatible with another device, and installing applications on that device using conventional installation methods instead of bulk installation via restoration of a false backup archive. Thus, in some implementations, the method further comprises:

(g) before (b), receiving by the second digital electronic device an indication that the restoration operation is compatible with the first digital electronic device;
(h) receiving by the second digital electronic device instruction to install a third plurality of applications on a third digital electronic device in communication with the second digital electronic device;
(i) receiving by the second digital electronic device an indication that the restoration operation is not compatible with the third digital electronic device; and
(j) causing by the second digital electronic device conventional installation of each application in the third plurality of applications on the third digital electronic device.

In another aspect, various implementations of the present technology provide a system for performing the above-described method. Thus, some implementations provide a digital electronic installation device for bulk installing, on a digital electronic target device, a first plurality of applications not already installed on the target device, the installation device comprising a communication interface structured and configured to communicate with the target device, and at least one processor operationally connected with the communication interface and structured and configured to:

(a) receive instruction to install the first plurality of applications on the first digital electronic device;
(b) create a false backup archive containing the first plurality of applications, the false backup archive having sufficient attributes of a true backup archive creatable by a backup operation in respect of the target device to be compatible with a restoration operation corresponding to the backup operation, the restoration operation executable to transfer contents of the false backup archive to a non-transitory computer-readable storage medium of the target device; and
(c) cause execution of the restoration operation, whereby the first plurality of applications is bulk installed on the target device.

In another aspect, various implementations of the present technology provide a storage medium having embodied thereon program instructions for performing the above-described method. Thus, some implementations provide a non-transitory computer-readable storage medium storing program instructions for bulk installing on a digital electronic target device a first plurality of applications not already installed on the target device, that when executed by at least one processor of a digital electronic installation device in communication with the target device, effect:

(a) reception by the installation device of instruction to install the first plurality of applications on the target device;
(b) creation by the installation device of a false backup archive containing the first plurality of applications, the false backup archive having sufficient attributes of a true backup archive creatable by a backup operation in respect of the target device to be compatible with a restoration operation corresponding to the backup operation, the restoration operation executable to transfer contents of the false backup archive to a non-transitory computer-readable storage medium of the target device; and
(c) causation by the installation device of execution of the restoration operation, whereby the first plurality of applications is bulk installed on the target device.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first device” and “third device” is not intended to imply any particular order, type, chronology, hierarchy or ranking (for example) of/between the devices, nor is their use (by itself) intended imply that any “second device” must necessarily exist in any given situation. Further, as is discussed herein in other contexts, reference to a “first” element and a “second” element does not preclude the two elements from being the same actual real-world element. Thus, for example, in some instances, a “first” device and a “second” device may be the same device, and in other cases they may be different devices.

In the context of the present specification, certain claim elements have been labeled with letters “(a)”, “(b)”, “(c)”, etc. These labels have been used only for ease of reference to the claim elements to which they refer, and not for the purpose of describing any particular relationship between those claim elements. The alphabetical nature of these labels is not intended to necessarily imply any particular order, chronology, hierarchy or ranking between the claim elements. Thus, for example, depending on the implementation, a method claim element with the label “(d)” may occur before, after, or simultaneously with a method claim element with the label “(b)”.

In the context of the present specification, a first device should be understood to be “in communication with” a second device if each of the devices is capable of sending information to and receiving information from the other device, across any physical medium or combinations of physical media, at any distance, and at any speed. As a non-limiting example, two digital electronic device(s) may communicate over a computer network such as the Internet. As another non-limiting example, the devices may run on the same digital electronic hardware, in which case communication may occur by any means available on such digital electronic hardware, such as inter-process communication.

In the context of the present specification, the expression “information” includes information of any nature or kind whatsoever capable of being stored on a non-transitory computer-readable storage medium. Therefore information includes, but is not limited to audiovisual works (pictures, movies, sound records, presentations etc.), data (location data, numerical data, etc.), text (opinions, comments, questions, messages, etc.), documents, spreadsheets, program instructions, etc.

In the context of the present specification, the expression “non-transitory computer-readable storage medium” is intended to include memory and media of any nature and kind whatsoever, including RAM, ROM, disks (CD-ROMs, DVDs, floppy disks, hard drives, etc.), USB flash drives, solid-state drives, tape drives, etc.

In the context of the present specification, the expression “application” includes any type of program instructions which may be executed by a digital electronic device equipped with suitable hardware and software, along with any information intended for use in conjunction with those program instructions. As non-limiting examples, applications may include stand-alone applications, widgets, software libraries, operating system components, and scripts.

In the context of the present specification, “installing” an application on a device refers to the process of making the program instructions of that application available for use by that device. Installation of an application generally includes copying information to a non-transitory computer-readable storage medium of the device.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a context diagram of a computing environment suitable for use with implementations of the present technology described herein;

FIG. 2 is a block diagram of hardware components of the smartphone of FIG. 1;

FIG. 3 is an example of a backup archive suitable for use with implementations of the present technology;

FIGS. 4A and 4B are an example of a graphical user interface for selecting applications to be installed; and

FIG. 5 is a flowchart representing a series of steps for carrying out bulk installation of applications, illustrating various aspects of the present technology.

### DETAILED DESCRIPTION

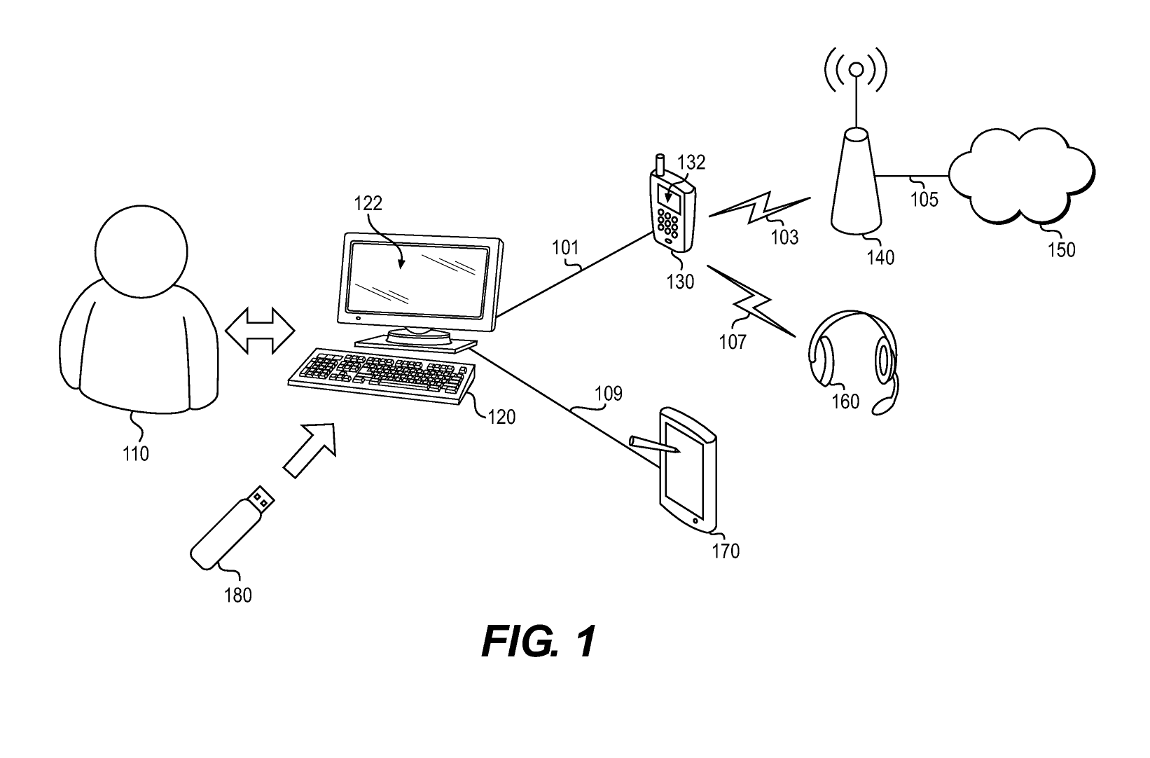

Referring to FIG. 1, there is shown a diagram of a computing environment 100 in communication with one another via various communications links. A user 110 interacts with a desktop PC 120 having a display 122. Desktop PC 120 is connected via a USB cable 101 to a smartphone 130 having a display 132 and running the GOOGLE ANDROID version 4.0 operating system. Smartphone 130 is in communication with a cloud-based online service 150 via a wireless communications link 103, a mobile communications network 140, and a network link 105. Smartphone 130 is paired with a BLUETOOTH headset 160 via a wireless BLUETOOTH link 107. Desktop PC 120 is also connected via a USB cable 109 to a tablet computer 170 running the GOOGLE ANDROID version 2.3 operating system. Finally, a USB flash drive 180 is inserted into a USB port of desktop PC 120 such that information on USB flash drive 180 may be read by desktop PC 120. In this implementation of the present technology, instructions for bulk installing applications on smartphone 130 via desktop PC 120 are stored on USB flash drive 180.

It is to be expressly understood that computing environment 100 comprises just some implementations of the present technology, and the description thereof that follows is intended to be only a description of illustrative examples of the present technology. This description is not intended to define the scope or set forth the bounds of the present technology. In some cases, what are believed to be helpful examples of modifications to computer systems 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. It is also to be understood that the computer systems 100 may provide in certain instances simple implementations of the present technology and that, where such is the case, they have been presented in this manner as an aid to understanding. As persons skilled in the art would understand, various implementations of the present technology may be of a greater complexity.

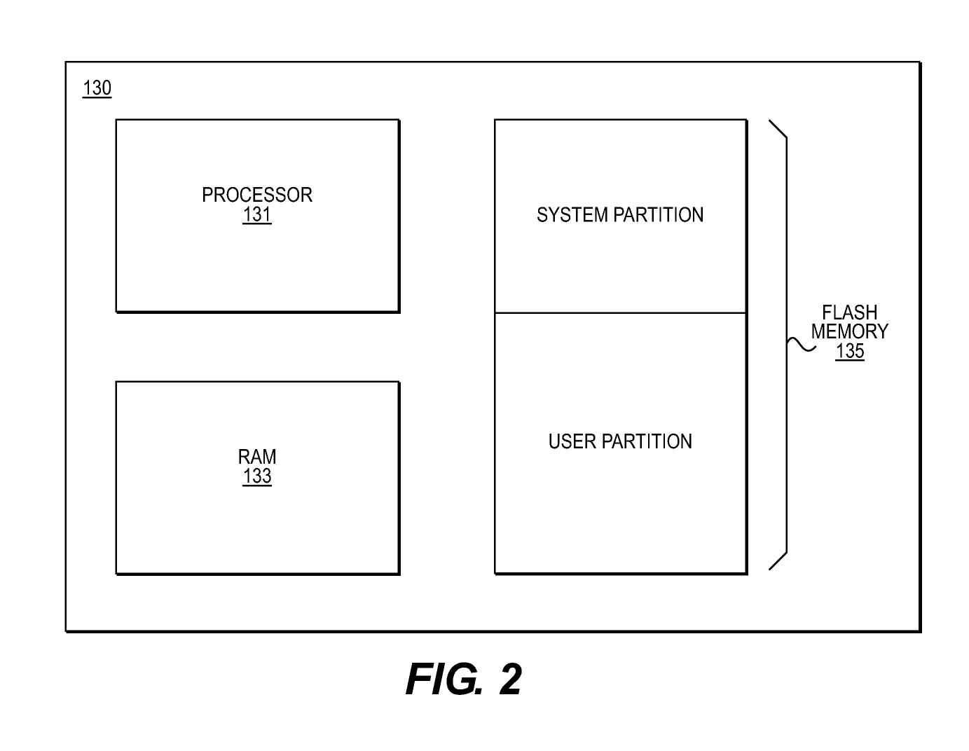

Referring to FIG. 2, there is shown a block diagram of smartphone 130. Apart from its display 132 (depicted in FIG. 1), smartphone 130 also comprises a processor 131, random access memory (RAM) 133, and flash memory 135 partitioned into a system partition and a user partition. The system partition hosts the operating system and files to be used by the operating system and system applications. The user partition hosts user applications and user data. In general, the contents of the system partition may only be modified by processes running with superuser permissions, commonly known as “root” permissions on UNIX and LINUX systems or “Administrator” rights on WINDOWS systems.

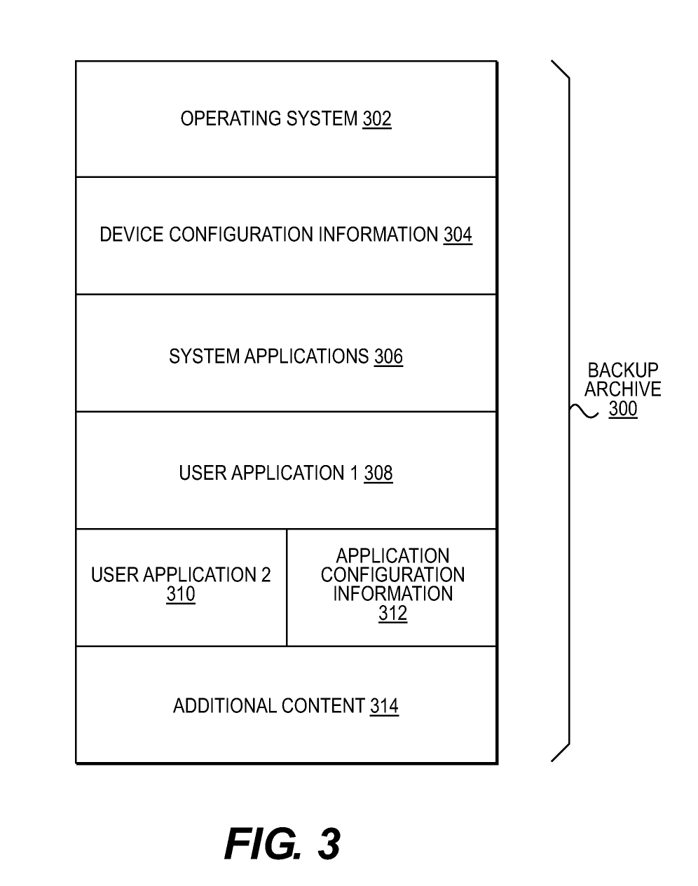

FIG. 3 shows a block diagram of a backup archive 300. The backup archive may include various types of files, such as operating system files 302, device configuration information 304, one or more system applications 306, one or more user applications 308, 310, . . . , application configuration information 312 in respect of one or more applications 312, and/or additional content 314. In the present implementation, the backup archive 300 is a GOOGLE ANDROID BACKUP “.ab” file created using the ANDROID Debug Bridge “adb backup” command of the GOOGLE ANDROID software development kit (SDK), available from GOOGLE's ANDROID developer website. When backed up in an uncompressed and unencrypted form, this “.ab” file may be treated as a standard “.tar” archive (also known as a “tarball”), meaning it can be manipulated using the standard “tar” command-line tool commonly found on UNIX and LINUX systems. In other implementations, the backup archive could be compressed and/or encrypted, and it could be organized as a different type of file, collection of files, or entry or entries in a database.

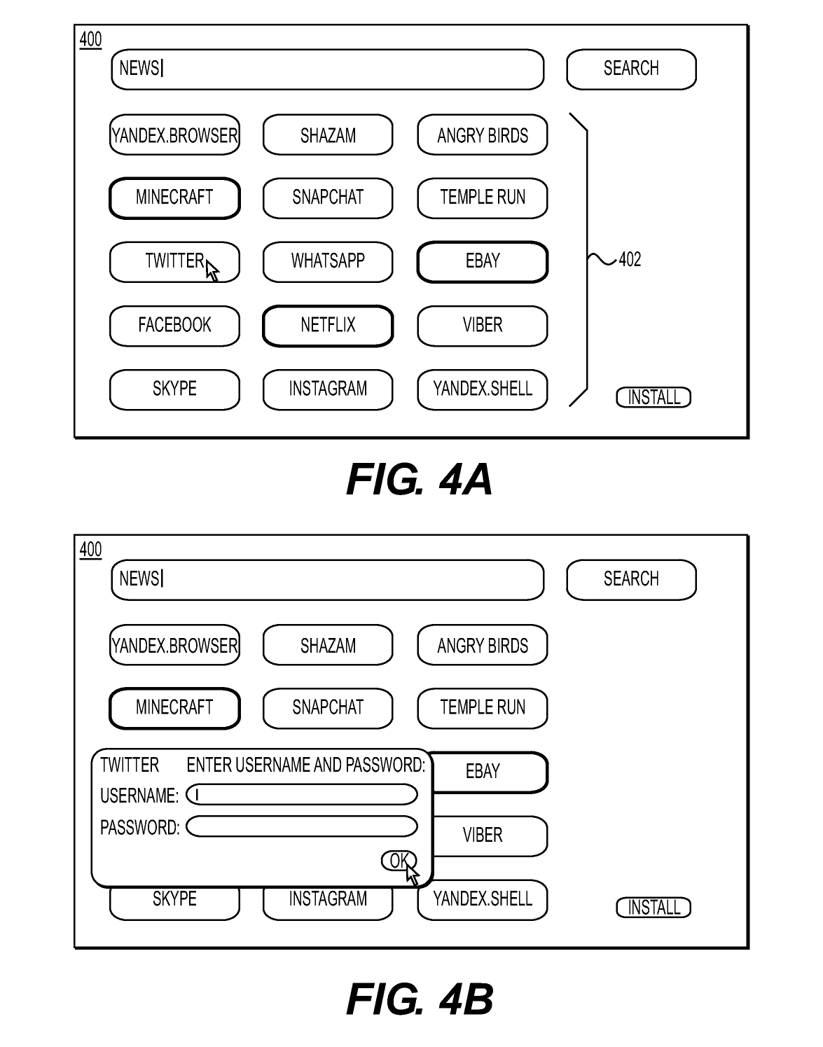

FIGS. 4A and 4B show an example of a graphical user interface 400 displayed on display 122 of computer 120 depicted in FIG. 1. User interface 400 allows user 110 to instruct computer 120 to install a plurality of applications on smartphone 130. In FIG. 4A, the user interface includes a search bar allowing user 110 to list applications available to be installed. The available applications are represented by buttons 402, which may be selected and deselected for installation by user 110 via one or more clicks of a mouse button, taps on a touchscreen, or other known user input means. In some implementations, application configuration information associated with one or more of the applications may be entered via the user interface. For example, FIG. 4B shows a pop-up window where a user 110 is prompted to enter a TWITTER username and password for the eventual user of smartphone 130 so the TWITTER application can be installed and with the user's login credentials preconfigured, such that upon using the Twitter application for the first time, the user will already be logged in. The user interface 400 may similarly prompt user 110 to enter other application configuration information or device configuration information such as a pairing code for a BLUETOOTH headset 160 (depicted in FIG. 1) or an unlock code to render smartphone 130 available for use on one or more mobile communications networks. In some implementations, the user interface 400 could also prompt the user to indicate the local or remote location of one or more files, e.g. documents, music, videos, or configuration files, to be copied into the backup archive 300 for installation on smartphone 130.

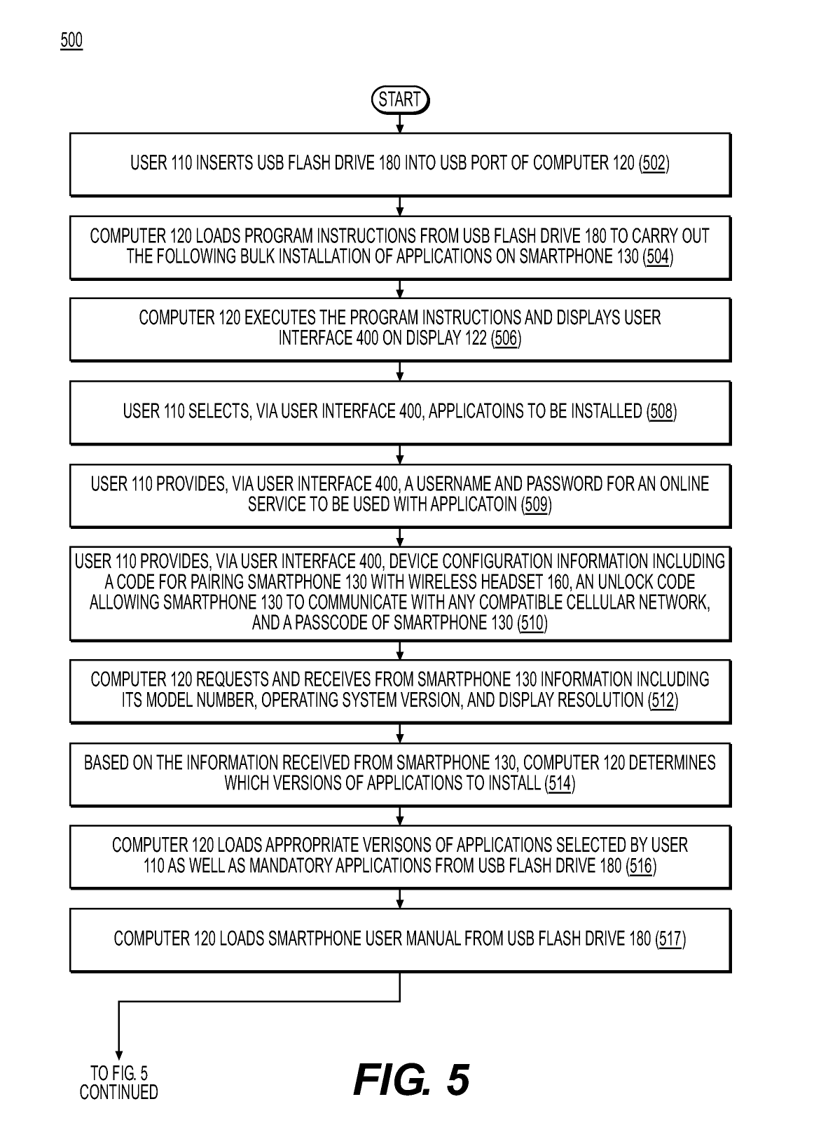

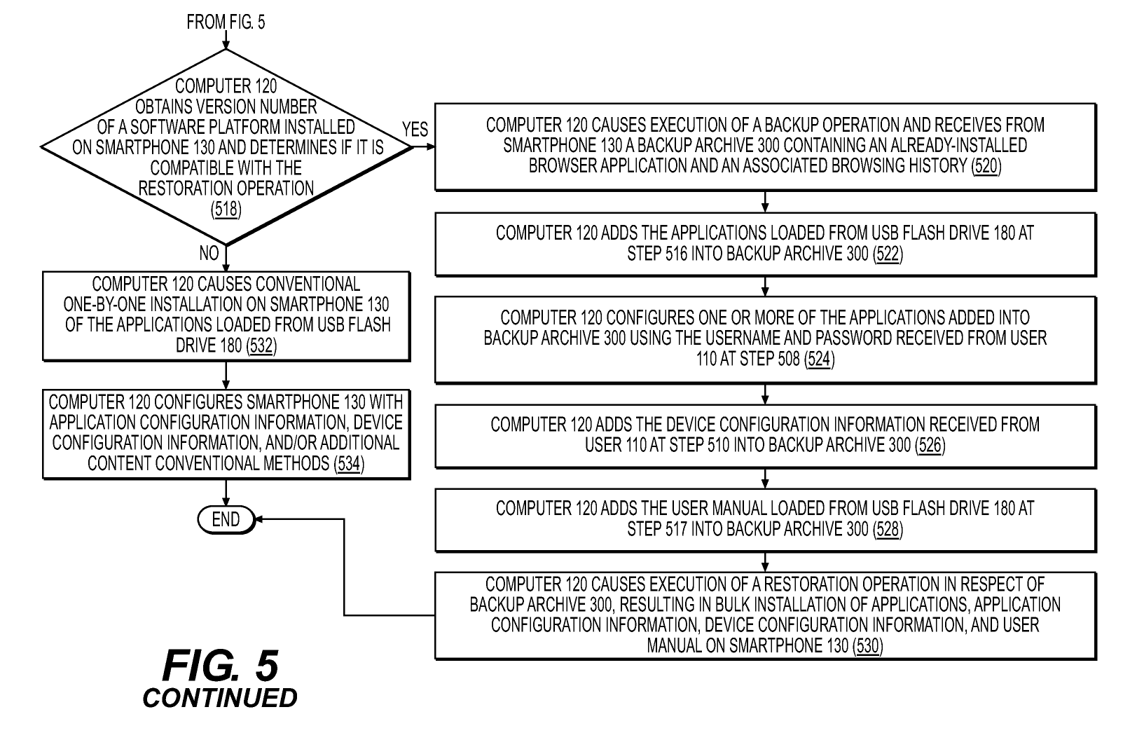

FIG. 5 shows a flowchart of a series of steps 500 for bulk installation of a plurality of applications on smartphone 130 in the context of the computing environment 100 as depicted in FIG. 1. At step 502, user 110 inserts USB flash drive 180 into a USB port of computer 120 and instructs computer 120 to load program instructions from the USB flash drive 180. In other implementations, USB flash drive 180 could be another type of portable non-transitory computer-readable storage medium, or the program instructions could be obtained from another device in communication with computer 120. At step 504, computer 120 loads the program instructions from USB flash drive 180 and begins to execute them in order to carry out the remaining steps of the bulk installation procedure. At step 506, computer 120 displays a graphical user interface 400 (such as that depicted in FIG. 4) on display 122. At step 508, user 110 makes a selection, via user interface 400, of applications to be installed on smartphone 130. At step 509, user 110 provides a username and password for an online service to be used with one or more applications via user interface 400 (e.g. the Twitter username and password entry prompt of FIG. 4B). At step 510, user 110 provides various types of device configuration information, namely a pairing code for BLUETOOTH headset 160, an unlock code to render smartphone 130 available for use on a mobile communications network such as a GSM, CDMA, or other cellular telephone network, and a passcode to gain access to smartphone 130. Other types of device configuration information and/or additional content could be provided by the user in other implementations. Also, in other implementations, there may be no user interface 400, and one or more of the applications to be installed, application configuration information, device configuration, and additional content may be determined based on information other than user input via a user interface, for example based on a configuration file or information received from another device.

At step 512, computer 120 requests and receives from smartphone 130 information including the model number of smartphone 130, the version of an operating system installed on smartphone 130 (e.g., GOOGLE ANDROID version 4.0), and the resolution of display 132. On GOOGLE ANDROID devices, for example, some of this information, such as the model number, is read from the “/system/build.prop” file. In other implementations, additional attributes of smartphone 130 may be obtained from smartphone 130, and/or one or more attributes of smartphone 130 may be entered by the user or obtained from a device other than smartphone 130. At step 514, computer 120 determines, based on one or more of the attributes retrieved from smartphone 130, which versions of the applications selected by user 110 and mandatory applications to install. For example, if an application has different versions, some requiring functionality introduced as of a particular operating system version (e.g. GOOGLE ANDROID version 4.0) and others being compatible with earlier versions of the operating system (e.g. GOOGLE ANDROID version 2.3), computer 120 checks the version number of smartphone 130's operating system and selects a compatible version of the application. In some implementations, other attributes of smartphone 130 could factor into this determination. At step 516, computer 120 loads the appropriate versions of the applications selected by user 110 (at step 508) from USB flash drive 180. In some implementations, computer 120 also loads mandatory applications not selected by user 110. In the present implementation, each application is contained in an ANDROID application package “.apk” file. In the present implementation, computer 120 also loads additional content from USB flash drive 180, in the form of a document containing a user manual for smartphone 130, at step 517.

In order to assess whether to proceed with bulk installation of the applications via restoration of a false backup image, at step 518 computer 120 tests whether the operating system installed on smartphone 130 is compatible with the restoration operation. In the present implementation, this consists of testing whether the application programming interface (API) level of the GOOGLE ANDROID operating system installed on smartphone 130 is at least 14: the lowest API level compatible with the ANDROID Debug Bridge “adb restore” command. If the API level is less than 14, as would be the case not for smartphone 130 but for another digital electronic device having installed thereon a version of GOOGLE ANDROID less than 4.0, such as tablet computer 170 (running Google Android version 2.3), computer 120 proceeds to conventional one-by-one installation of the applications at step 532. In the present implementation, this consists of a call to the ANDROID Debug Bridge command “adb install” in respect of each application's corresponding “.apk” file. At step 534, any application configuration information, device configuration information, and additional content could then also be installed on the digital electronic device using conventional methods, such as creating or modifying configuration files on smartphone 130 or making calls to an API available on smartphone 130.

But since smartphone 130 is running the GOOGLE ANDROID version 4.0 operating system, which has an API level of 14, computer 120 would detect that it is compatible with the ANDROID Debug Bridge “adb restore” restoration operation, and it would therefore proceed to bulk installation of the applications. Therefore, at step 520, computer 120 executes an ANDROID Debug Bridge “adb backup” command in respect of smartphone 130 and obtains a true backup archive 300 (with the “.ab” file type) containing a browser application already installed on smartphone 130 and a browsing history associated with the browser application. In other implementations, a backup archive 300 may instead be loaded from USB flash drive 180 or another device in communication with computer 120. In some such implementations, a plurality of backup archives may be stored on USB flash drive 180, each backup archive suitable to be restored to a prospective digital electronic device having certain attributes, such as a particular manufacturer and model number, and the appropriate backup archive 300 may be selected from among the backup archives by computer 120 based on one or more attributes of smartphone 130. At step 522, computer 120 adds the applications loaded from USB flash drive 180 at step 516 into backup archive 300—thus rendering backup archive 300 a false backup archive—while preserving sufficient attributes of the true backup archive to maintain compatibility with the ANDROID Debug Bride “adb restore” restoration operation. This may be performed, for example, by adding the “.apk” file corresponding to each application to be installed into the backup archive 300 using the “tar” command-line tool commonly available on UNIX and LINUX systems. At step 524, computer 120 configures one or more of the applications (e.g. TWITTER) added into backup archive 300 using the username and password received from user 110 at step 508, for example by creating or modifying a configuration file contained in backup archive 300. At step 526, computer 120 adds device configuration information (such as a pairing code, unlock code, or passcode) received from the user at step 510 into backup archive 300, for example by creating or modifying a configuration file contained in backup archive 300. At step 528, computer 120 adds the user manual loaded from USB flash drive 180 at step 517 into backup archive 300. In other implementations, other additional content could also be added. Finally, at step 530, computer 120 causes execution of a restoration operation such as the ANDROID Debug Bridge “adb restore” command in respect of backup archive 300, causing all of the applications, application configuration information, device configuration information, and additional content contained therein to be bulk installed on smartphone 130. In some implementations, computer 120 may also further configure smartphone 130 or add information to smartphone 130 using conventional methods such as creating or modifying configuration files or making calls to an available API.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A method of bulk installing on a first digital electronic device, from a second digital electronic device in communication with the first digital electronic device, a first plurality of applications, the method comprising:
(a) receiving by the second digital electronic device instruction to install, in bulk, the first plurality of applications on the first digital electronic device, the first plurality of applications not already installed on the first digital electronic device or the second digital electronic device;
(b) creating by the second digital electronic device a false backup archive containing the first plurality of applications, the false backup archive having sufficient attributes of a true backup archive creatable by a backup operation in respect of the first digital electronic device to be compatible with a restoration operation corresponding to the backup operation, the restoration operation executable to transfer contents of the false backup archive to a non-transitory computer-readable storage medium of the first digital electronic device; and
(c) causing by the second digital electronic device execution of the restoration operation, whereby the first plurality of applications is bulk installed on the first digital electronic device.

2. The method of claim 1, wherein:
an operating system of the first digital electronic device requires at least one operation to be executed with superuser permissions on the first digital electronic device; and
the restoration operation is executed without superuser permissions on the first digital electronic device.

3. The method of claim 2, wherein:
the operating system requires installation of system applications on the first digital electronic device to be executed with superuser permissions; and
the first plurality of applications includes no system applications.

4. The method of claim 1, wherein (b) includes combining the first plurality of applications with a true backup archive.

5. The method of claim 4, wherein (b) includes creating the true backup archive via the backup operation in respect of the first digital electronic device.

6. The method of claim 5, wherein the true backup archive contains at least one application already installed on the first digital electronic device; and (b) includes including the at least one application already installed in the false backup archive.

7. The method of claim 6, wherein the true backup archive contains state information associated with the at least one application already installed; and (b) includes including the state information in the false backup archive.

8. The method of claim 1, wherein (b) includes determining at least one attribute of the false backup archive based on at least one attribute of the first digital electronic device.

9. The method of claim 8, wherein (b) further includes receiving by the second digital electronic device from the first digital electronic device the at least one attribute of the first digital electronic device.

10. The method of claim 8, wherein (b) further includes selecting a version of at least one application included in the first plurality of applications based on the at least one attribute of the first digital electronic device.

11. The method of claim 8, wherein the at least one attribute of the first digital electronic device includes at least one of a manufacturer and a model number.

12. The method of claim 8, wherein the at least one attribute of the first digital electronic device includes at least one hardware attribute of the first digital electronic device

13. The method of claim 12, wherein the first digital electronic device includes a display and the at least one hardware attribute includes at least one of a size of the display and a resolution of the display.

14. The method of claim 8, wherein the at least one attribute of the first digital electronic device includes at least one of a version of an operating system of the first digital electronic device and a version of a software library installed on the first digital electronic device.

15. The method of claim 1, further comprising, before any of (a) to (c), loading by the second digital electronic device, from a portable removable non-transitory computer-readable storage medium connected to the second digital electronic device, program instructions for carrying out (a) to (c).

16. The method of claim 1, wherein the first digital electronic device is a mobile communications device.

17. The method of claim 16, wherein the first digital electronic device and the second digital electronic device are in communication via a USB cable.

18. The method of claim 1, wherein:
(a) includes receiving by the second digital electronic device via a user interface of the second digital electronic device a selection of at least one first application to be installed on the first digital electronic device; and
the first plurality of applications includes the at least one first application.

19. The method of claim 18, wherein:
the user interface is a graphical user interface; and
(a) further includes displaying via the graphical user interface a graphical representation of a second plurality of applications selectable for installation on the first digital electronic device, the second plurality of applications including the at least one first application.

20. The method of claim 18, wherein the first plurality of applications further includes at least one second application not having been selected via the user interface.

21. The method of claim 1, further comprising:
(d) receiving, by the second digital electronic device, application configuration information in respect of at least one third application in the first plurality of applications;
wherein (b) includes configuring the at least one third application using the application configuration information.

22. The method of claim 21, wherein the application configuration information includes user account information of a user of the first digital electronic device, the user account information uniquely identifying the user of the first digital electronic device to at least one online service associated with the at least one third application.

23. The method of claim 21, wherein at least some of the application configuration information is received by the second digital electronic device via the user interface of the second digital electronic device.

24. The method of claim 1, further comprising:
(e) receiving, by the second digital electronic device, device configuration information in respect of the first digital electronic device;
wherein (b) includes including the device configuration information in the false backup archive.

25. The method of claim 24, wherein the device configuration information includes information for pairing the first digital electronic device with at least one third digital electronic device.

26. The method of claim 24, wherein the device configuration information includes information for varying operability of the first digital electronic device with respect to at least one communications network.

27. The method of claim 24, wherein the device configuration information includes one of a passcode and an unlock code of the first digital electronic device.

28. The method of claim 24, wherein at least some of the device configuration information is received by the second digital electronic device via the user interface of the second digital electronic device.

29. The method of claim 1, further comprising:
(f) receiving, by the second digital electronic device, additional content;
wherein (b) includes including the additional content in the false backup archive.

30. The method of claim 1, further comprising:
(g) before (b), receiving by the second digital electronic device an indication that the restoration operation is compatible with the first digital electronic device;
(h) receiving by the second digital electronic device instruction to install a third plurality of applications on a third digital electronic device in communication with the second digital electronic device;
(i) receiving by the second digital electronic device an indication that the restoration operation is not compatible with the third digital electronic device; and
(j) causing by the second digital electronic device conventional installation of each application in the third plurality of applications on the third digital electronic device.

31. A digital electronic installation device for bulk installing, on a digital electronic target device, a first plurality of applications, the installation device comprising:
a communication interface structured and configured to communicate with the target device, and
at least one processor operationally connected with the communication interface and structured and configured to:
(a) receive instruction to install, in bulk, the first plurality of applications on the target device, the first plurality of applications not already installed on the target device or the installation device;
(b) create a false backup archive containing the first plurality of applications, the false backup archive having sufficient attributes of a true backup archive creatable by a backup operation in respect of the target device to be compatible with a restoration operation corresponding to the backup operation, the restoration operation executable to transfer contents of the false backup archive to a non-transitory computer-readable storage medium of the target device; and
(c) cause execution of the restoration operation, whereby the first plurality of applications is bulk installed on the target device.

32. A non-transitory computer-readable storage medium storing program instructions for bulk installing on a digital electronic target device a first plurality of applications, that when executed by at least one processor of a digital electronic installation device in communication with the target device, effect:
(a) reception by the installation device of instruction to install, in bulk, the first plurality of applications on the target device, the first plurality of applications not already installed on the target device or the installation device;
(b) creation by the installation device of a false backup archive containing the first plurality of applications, the false backup archive having sufficient attributes of a true backup archive creatable by a backup operation in respect of the target device to be compatible with a restoration operation corresponding to the backup operation, the restoration operation executable to transfer contents of the false backup archive to a non-transitory computer-readable storage medium of the target device; and
(c) causation by the installation device of execution of the restoration operation, whereby the first plurality of applications is bulk installed on the target device.
